(19) United States
(12) Patent Application Publication
(10) Pub. No.: US 2004/0187025 A1
(43) Pub. Date: Sep. 23, 2004

(54) Remote data update system

(75) Inventor: Osamu Tachiyama, Tokyo (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/391,567

(22) Filed: Mar. 20, 2003

(51) Int. Cl. G06F 11/30

(52) U.S. Cl. 713/201

(57) ABSTRACT

On the basis of a table where information indicating a state of each copying machine which is a management object is stored, a copying machine requiring update by update data is judged, and the update data is transmitted only to the copying machine requiring the update.

### BACKGROUND OF THE INVENTION

The present invention relates to an update system of data and an update method of data, for example, in which the data stored in memories in a plurality of copying machines connected to a management server of a service station (support center) via a network are updated.

In conventional image forming devices such as a copying machine, when defects (such as a bug) are found in software (data) stored in ROM, and the like, a serviceman goes to each image forming device to update the software. In this system, there is a problem that much cost is required for updating the software or that the defect of the software cannot be easily and quickly dealt with.

Moreover, in recent years, for the image forming devices such as a digital copying machine, there has been a device which has a function enabling connection to a network, such as the Internet. Such an image forming device can receive technical support from the service station via the Internet. A management server which can be connected to a plurality of image forming devices is disposed in the service station. The management server of the service station can transmit/receive the data with respect to each image forming device.

In this system, if defects (such as bugs) are found in the software stored in the ROM, and the like in the image forming device, the service station transmits data to update each image forming device via the network, and each image forming device can update the data.

However, in the above-described system, the service station sends a request for the update of the data to each image forming device regardless of an installation or operation situation of each image forming device. Therefore, the request for the update is sometimes performed also with respect to an image forming device which does not require any version upgrade. In this case, even when it is unnecessary to update the data, the image forming device executes the update in response to the request from the service station.

Usually, in image forming devices such as digital copying machine, during the execution of an update, the use of the image forming device by a user is impossible, which is a problem.

Moreover, there is a possibility that an error is generated by an unexpected situation in updating the software. Especially, when the update of the software stored in the ROM fails, there is a possibility that the image forming device does not normally operate. That is, when the unnecessary update is carried out, there is a problem that a useless risk is taken.

Furthermore, when the service station transmits update data for an update to a plurality of image forming devices that do not need updating, communication traffic needlessly increases, which is a problem.

### BRIEF SUMMARY OF THE INVENTION

An object of the present invention is to provide a management server which can allow each image forming device in a system to efficiently execute update of software without any waste, an update system of data, and an update method of the data.

According to the present invention, there is provided a management server connected via a network to a plurality of devices each of which can selectively be connected to various optional apparatuses each including at least one memory and each of which comprises a main body including at least one memory, the management server comprising: a table where information indicating a state of each device which is a management object is stored; a judgment section which judges a device requiring update based on the information stored in the table to indicate the state of each device, when update data is acquired with respect to data stored in the memory in each device which is the management object; and a communication interface which transmits the update data to the device judged to require the update by the judgment section.

According to the present invention, there is provided an update system of data, comprising: a plurality of devices each of which can selectively be connected to various optional apparatuses each including at least one memory and each of which comprises a main body including at least one memory; and a management server connected to these devices via a network, wherein the management server comprises: a table where information indicating a state of each device which is a management object is stored; a judgment section which judges a device requiring update based on the information stored in the table to indicate the state of each device, when update data is acquired with respect to data stored in the memory in each device which is the management object; and a first communication interface which transmits the update data to the device judged to require the update by the judgment section, and each device comprises: a second communication interface in which data communication is possible with respect to the management server; a distinction section which identifies a memory which is an object of the update by the update data received from the management server by the second communication interface; and a rewrite processing section which carries out a rewrite process with respect to the data stored in the memory identified by the distinction section based on the update data.

According to the present invention, there is provided an update method of data by a management server connected to a plurality of devices each of which can selectively be connected to various optional apparatuses each including at least one memory and each of which comprises a main body including at least one memory via a network, the method comprising: storing information indicating a state of each device which is a management object in a table; judging a device requiring update based on the information which is stored in the table and which indicates the state of each device, when update data is acquired with respect to the data stored in the memory in each device which is the management object; and transmitting the update data with respect to the device judged to require the update by the judgment.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a diagram schematically showing a constitution of a network system;

FIG. 2 is a block diagram showing schematic constitutions of a management server and copying machine;

FIG. 3 is a diagram showing a constitution example of a table;

FIG. 4 is a flowchart showing an operation of update in the management server;

FIG. 5 is a flowchart showing an approval procedure;

FIG. 6 is a flowchart showing an error process;

FIG. 7 is a flowchart showing an operation of the copying machine; and

FIG. 8 is a flowchart showing a process associated with a change of an optional apparatus constitution of the copying machine.

### DETAILED DESCRIPTION OF THE INVENTION

An embodiment of the present invention will be described with reference to the drawings.

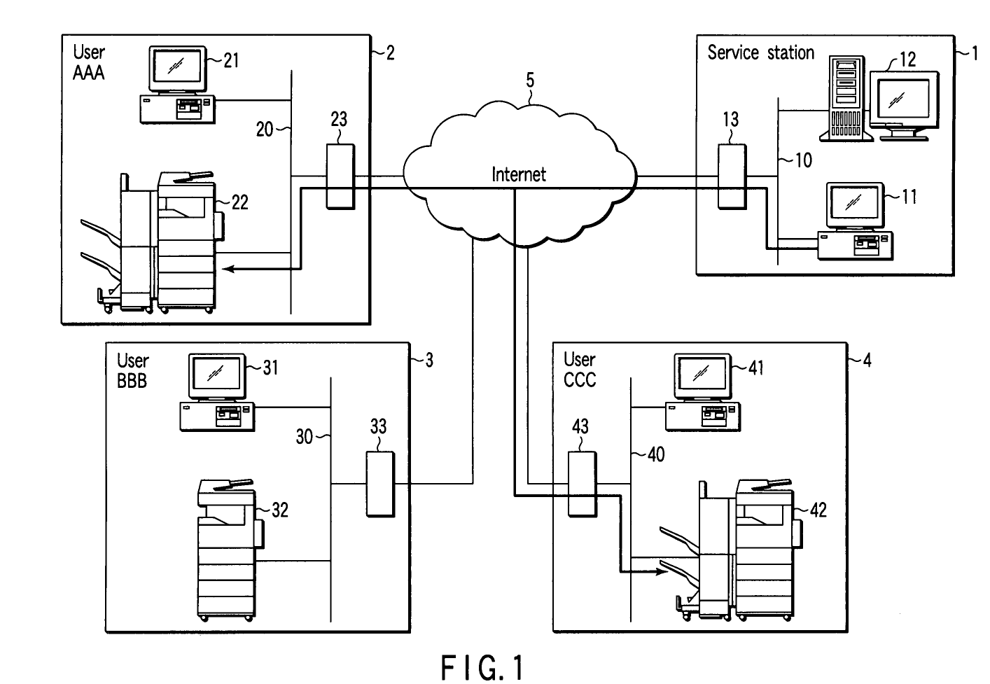

FIG. 1 is a diagram showing a schematic constitution of a network system according to an update system of data of the present invention.

As shown in FIG. 1, this update system comprises a service station system 1, a plurality of user systems 2, 3, 4, and Internet 5.

In the service station system 1, technical support is provided for copying machines 22, 32, 42 of the respective user systems 2, 3, 4. For the technical support, for example, data stored in a ROM in each copying machine 22 (32, 42) is updated (version upgrade process of data). Each of the user systems 2, 3, 4 is a system including the copying machine 22 which is used by at least one user.

The service station 1 is constituted of a management server 11, management terminal 12, and relay device 13 connected to one another by a local area network 10. Each user system 2 (3, 4) is constituted of a user terminal 21 (31, 41) and the copying machine 22 (32, 42) connected to each other by a local area network 20 (30, 40). It is to be noted that each of the user systems 2, 3, 4 may be a system which does not include the user terminal 21 (31, 41) and which is constituted only of the copying machine (device which is a management object) 22 (32, 42) capable of performing data communication with the service system via the Internet 5. Each user system 2 (3, 4) may be constituted to include a plurality of copying machines in a local area.

The relay devices 13, 21, 31, 41 carry out relay processes of transmission/reception data between the Internet 5 and local area networks 10, 20, 30, 40, and transmission/reception data among the respective devices in the respective local area networks 10, 20, 30, 40.

The management server 11 is constituted of a server computer. The management server 11 has a function of carrying out the transmission/reception of the data with respect to the copying machine 22 (32, 42) of each user system or the user terminal 21 (31, 41) via the Internet 5. Furthermore, the management server 11 includes a table by which the constitution of each copying machine 22 (32, 42) and version information of program stored in the ROM in each copying machine 22 (32, 42) are managed.

The management terminal 12 is a terminal operated by a serviceman of the service station. The management terminal 12 uploads update data inputted by the service man into the management server 11.

The user terminal 21 (31, 41) is constituted, for example, of a personal computer. The user terminal 21 (31, 41) is a terminal device used by each user. The user terminal 21 (31, 41) is connected to the copying machine 22 (32, 42) in each local area network 20 (30, 40).

The copying machine 22 (32, 42) is constituted, for example, of a digital combined machine (MFP). The copying machine 22 (32, 42) includes at least a scanner function, printer function, network communication function, and copy function. Furthermore, the copying machine 22 (32, 42) can realize various optional functions in accordance with an installation situation of the optional apparatus.

Examples of the optional apparatus include a finisher, ADF, facsimile unit, large-capacity sheet feed device, multistage sheet feed device, hole punch unit, and network expansion unit.

The finisher performs a finishing process of sheets discharged from a copying machine main body. The ADF is a device for feeding the sheets to a read position of a scanner section 122 one by one. The facsimile unit performs a transmission/reception process of facsimile data via a phone circuit, Internet, or local area network. The large-capacity sheet feed device is a sheet feed device including a sheet feed stage having a large capacity in which a large number of sheets can be contained to supply the sheets contained in the sheet feed stage to the copying machine main body one by one. The multistage sheet feed device includes a plurality of stages and can selectively feed a plurality of types of sheets to the copying machine main body. The hole punch unit performs a process of making punch holes with respect to the sheet discharged from the copying machine main body. The network expansion unit realizes expansion of a network function in which various processes are possible via the network.

Next, the constitutions of the management server 11 and copying machine 22 (32, 42) will be described.

First, the constitution of the management server 11 will be described.

The management server 11 includes a CPU 101, main memory 102, ROM 103, HDD 104, and LAN interface (I/F) 105. The CPU 101 performs overall control of management server 11.

The CPU 101 includes a clock 101a which measures time. The main memory 102 is constituted of a RAM. The main memory 102 temporarily stores data for operation. In the ROM 103, an operating system program is stored for basic operation of the management server 11. The storage device 104 is constituted of a hard disk drive. The storage device 104 stores an application program. The storage device 104 also includes a table 104a (104b, . . . ) in accordance with the type of copying machine managed by the service station. The LAN interface 105 performs data communication in the local area network.

By the constitution described above, the CPU 101 operates based on the control programs stored in the ROM 103 and storage device 104. When communicating with another device via the Internet, the CPU 101 transmits/receives the data with respect to the relay device 13 via the LAN interface 105.

Next, a constitution example of the copying machine 22 (32, 42) will be described.

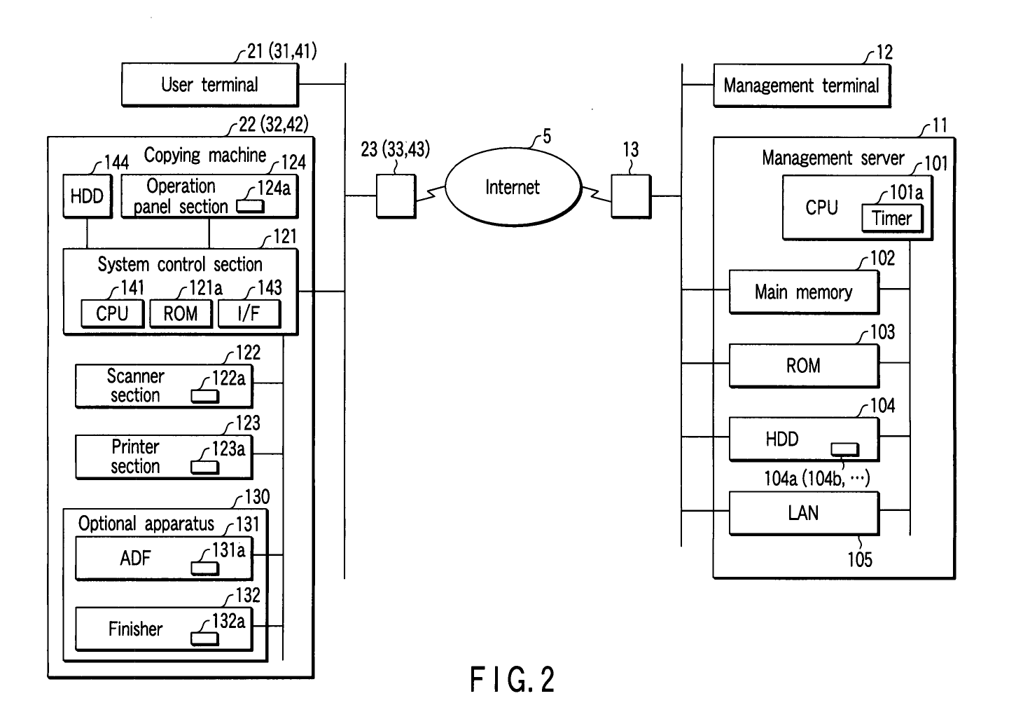

As shown in FIG. 2, the copying machine 22 (32, 42) includes at least a system control section 121, scanner section 122, printer section 123, and operation panel section 124. Furthermore, it is possible to dispose an optional apparatus in the copying machine. In the example shown in FIG. 2, the optional apparatus includes an ADF 125, finisher 126, and the like.

Each of the sections 121 to 126 includes at least one rewritable ROM 121a to 126a. The ROMs 121a to 126a are constituted, for example, of EEPROM, and data (software), such as a control program necessary for the operation of each section, is stored.

The system control section 121 controls the whole copying machine. The scanner section 122 optically reads an image of a draft. The printer section 123 prints the image onto a medium on which the image is to be formed. The operation panel section 124 is a user interface including a liquid crystal display device in which a touch panel is incorporated.

Moreover, the system control section 121 includes a CPU 141, ROM 121a, and LAN interface 143. The system control section 121 is connected to an HDD 144. By this constitution, in the system control section 121, the CPU 141 controls the operation of each section based on the control program stored in the ROM 121a.

For example, when a read process of a plurality of drafts is performed in the copying machine connected to the ADF 131, the system control section 121 controls the ADF 131 and scanner section 122. Accordingly, the copying machine performs a process of reading the images of the drafts supplied one by one by the ADF 131.

Moreover, the finisher 132 is connected so that a print operation is performed in the copying machine. In this case, the system control section 121 controls the printer section 123 and finisher 132. Accordingly, the copying machine performs a finishing process with respect to the sheet printed/processed in the printer section 123. It is to be noted that the finishing process is a process for the sheet discharged from the copying machine main body. Examples of the process include a sorting process of the sheets by an electronic sorter, and a staple process of stapling each set of a plurality of sheets.

Furthermore, the management terminal 12 and user terminal 21 (31, 41) include a constitution similar to that of a conventional personal computer, and include control sections such as a CPU, operation sections such as a keyboard, display sections such as a CRT and LCD, storage sections such as an HDD, and network interfaces. Moreover, the management terminal 12 and user terminal 21 (31, 41) can transmit/receive a mail with respect to another device by the network interface via the internet or local area network.

Next, the table 104a will be described.

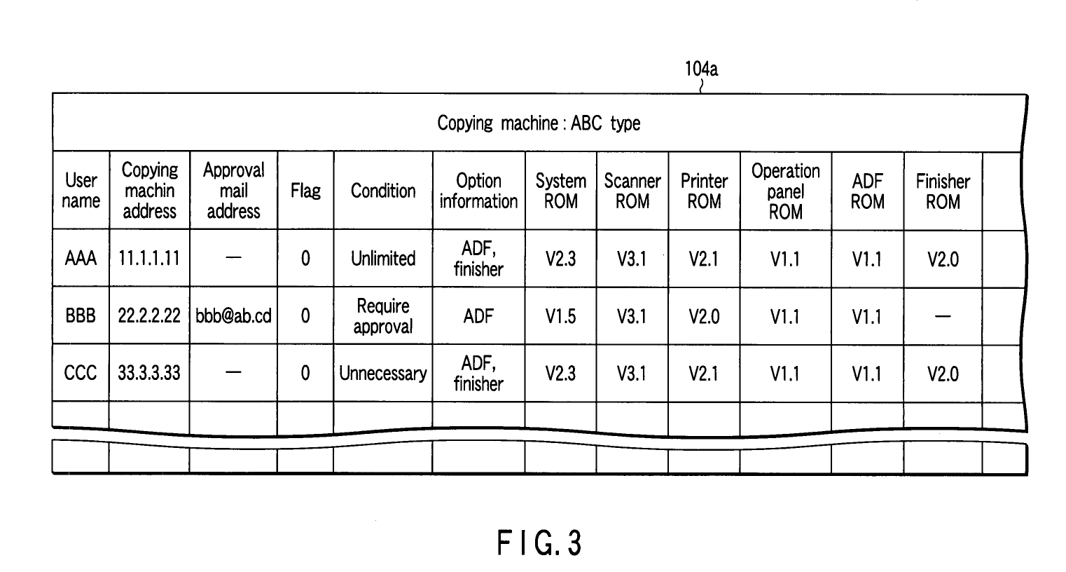

FIG. 3 is a diagram showing an example of the table 104a.

FIG. 3 shows an example of the table with respect to the copying machine whose model is an ABC type. As shown in FIG. 3, the table is prepared for each model (type) of copying machine. Therefore, when the service station manages several types of copying machines, the same number of tables as that of types of copying machines are prepared in the management server 11 as shown in FIG. 3.

Furthermore, in the example of the table 104a shown in FIG. 3, for each of the plurality of copying machines (users), a “user name”, “address of the copying machine”, “approved mail address”, “flag”, “condition”, “option information”, “ROM information of each section” (“system ROM”, “scanner ROM”, “printer ROM”, “operation panel ROM”, “ADFROM”, “finisher ROM”, etc.), and the like are stored.

The “user name” is information for identifying each copying machine. As shown in FIG. 1, when only one copying machine is disposed in one user system (local area), the user name may be information indicating the user. Alternatively, when a plurality of copying machines exist in one user system (within the local area), the user name may be not only the information indicating the user but also information which can specify each copying machine.

The “address of the copying machine” indicates an address to which the management server 11 can transmit the data for the copying machine via the internet 5. The “approved mail address” is information indicating a mail address of the user or manager of each copying machine. The “main address” is set to the copying machine which requires an approval procedure of update described later. That is, for the “mail address”, a mail address is stored as the address of a mail requesting for the approval of the update.

The “flag” indicates whether or not the copying machine is executing actual update. The “flag” is on (information indicating that the update process is being performed), for example, when the data for the update (update data) is transmitted to the copying machine. The flag is off (information indicating that the update process is not performed) at a time when a completion notice of the update is received from the copying machine.

The “condition” indicates a condition in executing the update of the software of the copying machine. The “option information” is information indicating the optional apparatus connected to the copying machine main body.

The “ROM information of each section” is information on the optional apparatus connectable to the copying machine and the ROM of each included section. That is, in the example shown in FIG. 2, as the “ROM information of each section”, at least the “system ROM”, “scanner ROM”, “printer ROM”, “operation panel ROM”, “ADFROM”, “finisher ROM”, and the like are stored.

The “system ROM” is information indicating a version of the data (software) such as the control program stored in the ROM 121a in the system control section 121 of the copying machine.

The “scanner ROM” is information indicating the version of the data (software) such as the control program stored in the ROM 122a in the scanner section 122 of the copying machine.

The “printer ROM” is information indicating the version of the data (software) such as the control program stored in the ROM 123a in the printer section 123 of the copying machine.

The “operation panel ROM” is information indicating the version of the data (software) such as the control program stored in the ROM 124a in the operation panel section 124 of the copying machine.

Furthermore, the “ADFROM” is information indicating the version of the data (software) such as the control program stored in the ROM 131a in the ADF 131 of the copying machine, when the ADF 131 is disposed as the optional apparatus in the copying machine.

The “finisher ROM” is information indicating the version of the data (software) such as the control program stored in the ROM 132a in the finisher 132 of the copying machine, when the finisher 132 is disposed as the optional apparatus in the copying machine.

It is to be noted that when the optional apparatus other than the ADF and finisher can be connected, the information indicating the version of the data stored in the ROM is stored in the table 104a in accordance with each optional apparatus.

Next, the condition of the update stored in the table 104a will be described as the above-described “condition”.

Usually for the copying machine, when the update stored in the ROM in the copying machine is started, and while the update process is executed, another operation is prohibited. Therefore, when the service station automatically execute the update process with respect to all the copying machines, there is a possibility that user's convenience is impaired.

That is, the condition in updating the copying machine is stored in the “condition” of the table 104a in response to a proposal from the user or manager of each copying machine. According to the “condition” of the table 104a described above, only when the “condition” is satisfied, the management server 11 executes the update with respect to each device. Accordingly, in the predetermined network system, the update of the copying machine can automatically be executed in response to the user's request without impairing the user's convenience.

For example, when the “condition” is “unlimited”, there is no limitation in the update with respect to the copying machine. Therefore, when the “condition” is “unlimited”, the management server 11 starts the update with respect to the copying machine on acquiring information to be updated.

Moreover, when the “condition” is assumed to “require approval”, the update with respect to the copying machine is executed after receiving a notice (approval) indicating that the update is permitted from the user or manager. Conversely, when the “condition” is assumed to “require approval”, and when there is not any notice indicating the permission of the update from the user or manager, the update with respect to the copying machine is not executed.

Furthermore, when the “condition” is “unnecessary”, the update with respect to the copying machine is not executed. Therefore, when the “condition” is “unnecessary”, the management server 11 does not perform the update with respect to the copying machine even when acquiring the information to be updated.

Additionally, for the “condition”, a limitation may be imposed on the update by a time limitation and the type of data to be updated such as “a time when the update is possible” and “a type of data to be updated”. The update may also be limited by a condition obtained by combining a plurality of conditions.

For example, when the time designated by the user is set as the condition of the update, it is possible to execute the update only at a time convenient for the user, such as late at night and outside duty hours. Moreover, the update is set so as to be performed only for a critical software bug by which the operation of the copying machine itself is impossible. Then, such an update that may cause trouble in the usual operation can be prevented from being carried out. Furthermore, when a plurality of conditions are set, a limitation is possible such that the update is performed only in clearing all the plurality of conditions.

Next, the operation of the management server 11 will be described.

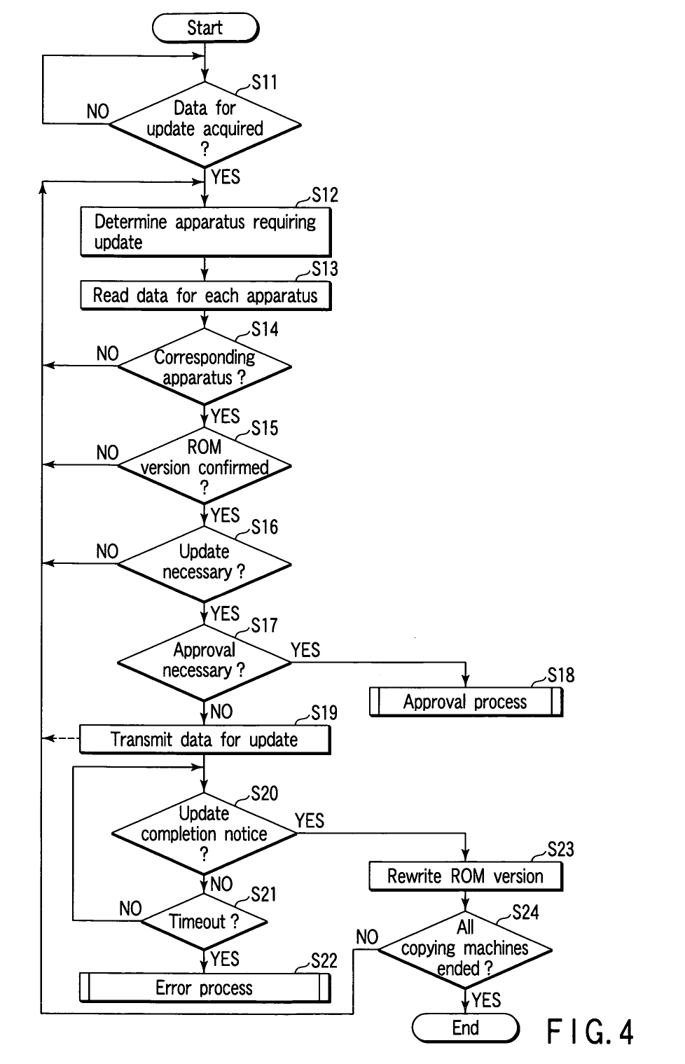

FIG. 4 is a flowchart showing the operation of the management server 11.

First, for example, when acquiring certain update data of the ROM, the service man in the service station inputs the update data by the management terminal 12, and transmits the data to the management server 11. Then, the CPU 101 of the management server 11 starts updating the data with respect to each copying machine in the system.

Here, it is assumed that the update data is data such as the control program stored in the ROM of each device in the copying machine. When the update data is inputted, the type (model) of the copying machine, the information indicating the device which is the object of the update (system control section, scanner section, printer section, operation panel section, ADF, finisher, other optional apparatuses), and the version information of the update data are inputted together with the update data per se in the management server 11.

That is, when the update data for the update is inputted into the management server 11, the CPU 101 first judges the type (model) of the copying machine which is the object of the update by the update data. Based on this judgment, the CPU 101 judges the table for use. It is to be noted that here the operation will be described assuming that the table 104a is applied.

Furthermore, when the management server 11 acquires the update data for the update (step S11, YES), the CPU 101 determines the device to be updated (option constitution of the copying machine) (step S12). For example, when the update data is data for updating the control program stored in the ROM 132a of the finisher 132, the CPU 101 determines that the device to be updated is the finisher 132.

Subsequently, the CPU 101 reads the data for one device from the table 104a (step S13). On reading the data concerning one copying machine from the table 104a, the CPU 101 judges whether or not the device to be updated is included based on the option information concerning the copying machine (step S14).

When the copying machine is judged not to include the device to be updated by this judgment (step S14, NO), the CPU 101 judges that the copying machine is not the object of the update, and returns to the step S13.

Moreover, when the copying machine is judged to include the device to be updated by the judgment (step S14, YES), the CPU 101 judges whether or not the ROM version of the device to be updated of the copying machine (the version of the data such as the control program stored in the ROM of the device) is older than the version of the update data (step S15).

When it is judged that the version is not older than that of the update data by this judgment, that is, when it is judged that the version of the ROM is the same as or newer than that of the update data (step S15, YES), the CPU 101 judges that the copying machine is not the object of the update, and returns to the step S13.

Moreover, when it is judged that the version of the ROM is older than that of the update data by this judgment (step S15, NO), the CPU 101 judges whether or not the process of the update is necessary based on the update condition stored in the table 104a with respect to the copying machine (step S16). For example, when the “condition” is “unnecessary” in the table shown in FIG. 3, the CPU 101 judges that the update of the copying machine is unnecessary.

When it is judged that the update is unnecessary by this judgment (step S16, NO), the CPU 101 judges that the copying machine is not the object of the update, and returns to the step S13.

Moreover, when it is judged by this judgment that the process of the update is necessary (step S16, YES), the CPU 101 further judges whether or not an approval procedure (approval process) is necessary with respect to the update of the copying machine based on the update condition (step S17). For example, when the “condition” is “unlimited” as shown in FIG. 3, the CPU 101 judges that the update is started with respect to the copying machine without any approval procedure. When the “condition” is assumed to “require the approval”, the CPU 101 judges that the approval procedure is necessary before updating the copying machine.

When it is judged by the judgment that the approval procedure is necessary with respect to the update (step S17, YES), the CPU 101 executes the approval procedure (approval process) concerning the update of the copying machine (step S18). In this case, the CPU 101 executes the update process similar to that of steps S19 to S23 after the update of the copying machine is approved by the user or manager by the approval process. The approval process will be described later.

Moreover, when it is judged by the judgment that the approval procedure is necessary with respect to the update (step S17, NO), the CPU 101 transmits the data for the update (update data) to the copying machine (step S19). In this case, the CPU 101 designates the address of the copying machine based on the content of the table 104a to transmit the update data.

When the update data is transmitted, the CPU 101 waits for a notice of update completion from the copying machine for at least a predetermined time (steps S20, S21). It is to be noted that in the actual process, as shown by a dotted line in FIG. 4, on transmitting the update data to one copying machine, the CPU 101 waits for the notice of the update completion from the copying machine, and advances to the step S13 to perform the similar process with respect to the next copying machine.

When the update completion notice cannot be received from the copying machine within the predetermined time (step S21, YES), the CPU 101 performs an error process (step S22). The error process will be described later.

On receiving the update completion notice from the copying machine (step S20, YES), the CPU 101 rewrites version information with respect to the ROM of the copying machine in the table 104a into the version of the update data (step S23). Accordingly, a series of update processes concerning the control program ends.

Moreover, the CPU 101 executes the process of the steps S13 to S23 with respect to all the copying machines in the table 104a. Therefore, when the process ends with respect to all the copying machines in the table 104a, the CPU 101 ends the operation in acquiring the update data.

As described above, when acquiring the update data for updating the copying machine as the management object, the management server judges the necessary copying machine requiring the update based on the table where the state of each copying machine is stored, and transmits the update data only to the copying machine requiring the update. Accordingly, only the copying machine actually requiring the update can be allowed to update the update data.

Moreover, when acquiring the update data for updating the copying machine as the management object, the management server judges the copying machine including the device as the object of the update based on the table where the device constitution of each copying machine is stored, and transmits the update data only to the copying machine including the device which is the object of the update. Accordingly, the update can be executed with respect to only the copying machine including the device which is the object of the update.

Furthermore, when acquiring the update data for updating the copying machine which is the management object, the management server judges the copying machine including the ROM in which the data of the version requiring the update by the update data based on the table where the version information of the data stored in each ROM in each copying machine is stored, and transmits the update data only to the copying machine requiring the update by the update data. Accordingly, the update can be executed with respect to only the copying machine including the ROM in which the data of the version requiring the update is stored.

Next, the approval procedure of the update will be described.

Various methods of the approval procedure of the update which can be applied to the present system are considered. For example, a mail requesting for the approval is transmitted to the manager or user of the copying machine so that the approval may be obtained by a return to this mail. Alternatively, the management server 11 may receive the approval based on indication of an approval key by the user of each copying machine. Furthermore, when a specific person (manager) manages a plurality of copying machines, the manager predetermines the specific copying machine (parent machine) among the plurality of copying machines. The approval may also be obtained based on the indication of the approval key by the manager in the parent machine.

Moreover, when the approval procedure is necessary, various methods of transmitting the update data are considered. For example, after obtaining the approval from the manager or user, the management server 11 may transmit the update data to the copying machine. Alternatively, the update data is first transmitted to the copying machine (in this case, it is assumed that the update data is stored in the HDD in the copying machine). After obtaining the approval from the manager or user, the copying machine may be instructed to execute the update.

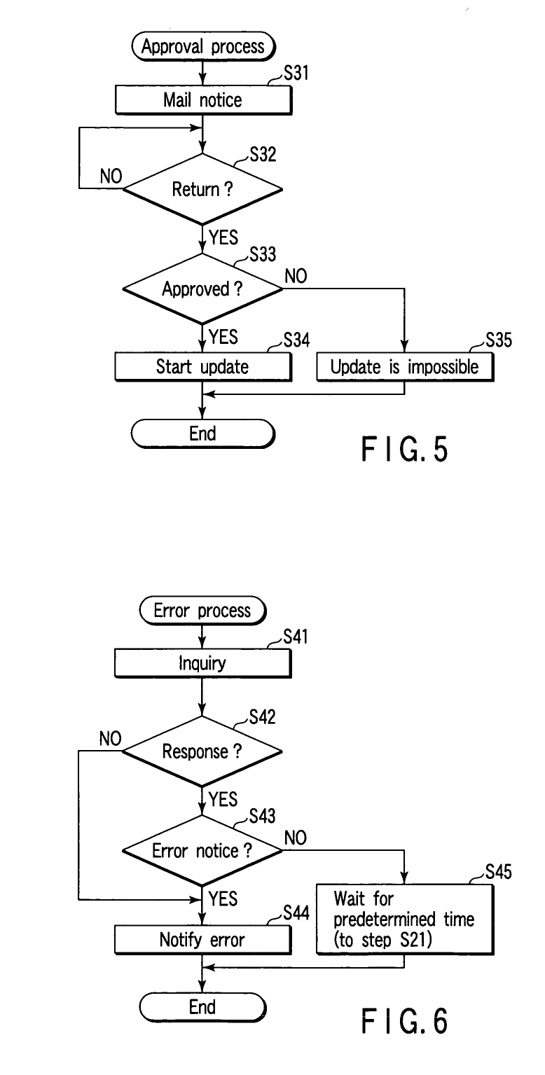

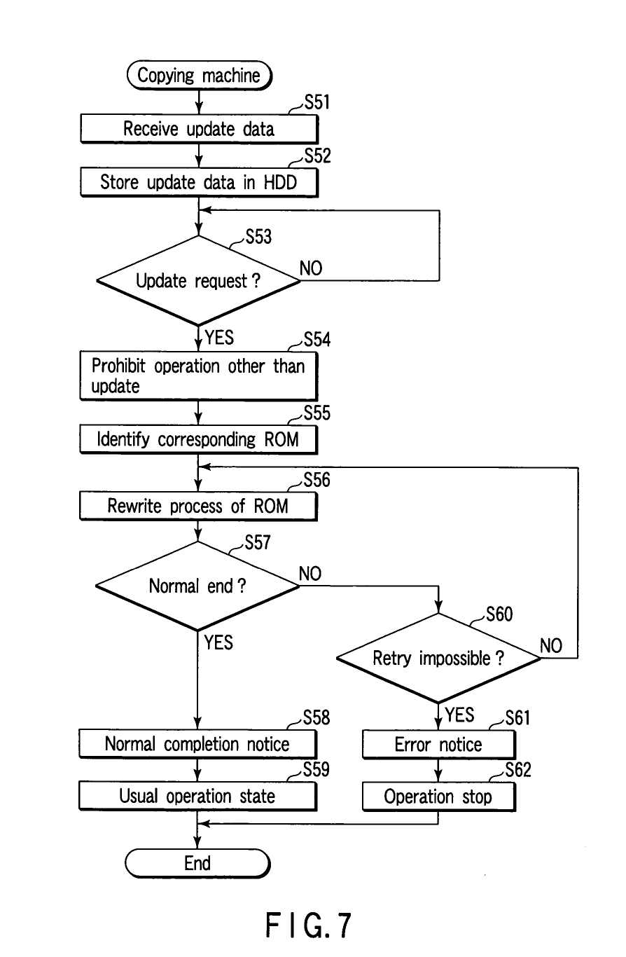

FIG. 5 is a flowchart showing one example of the approval procedure of the update. It is to be noted that here the approval of the update is requested with respect to the manager or user by the mail, and the update is approved by the return mail from the manager or user. In this case, the management server 11 executes the process shown in the steps S19 to S23.

That is, when it is judged in the step S17 that the approval procedure is necessary, the CPU 101 starts the approval procedure. First, the CPU 101 prepares the mail requesting for the approval of the update by the update data, and transmits the mail to the mail address stored in the table 104a (step S31).

After the request for the approval of the update is transmitted, the management server 11 monitors presence/absence of the return to the mail (step S32). When the management server 11 receives the return mail to the mail, the CPU 101 judges whether or not the content of the return mail indicates the approval of the update by the update data (step S33). When it is judged by the judgment that the update is approved by the return mail, the CPU 101 judges the start of the update (step S34), and executes the process of the steps S19 to S23.

Furthermore, when it is judged that the update is not approved, the CPU 101 judges that the update is impossible with respect to the corresponding copying machine (step S35). When it is judged that the update is impossible in this manner, the CPU 101 may notify the manager that the approval has not been approved.

Moreover, to perform the above-described approval procedure, the “flag” of the table 104a may be turned on, when the mail requesting for the approval of the update is transmitted. The flag may also be turned on, when the update is approved and the update data is transmitted. When the mail requesting for the approval of the update is transmitted and the “flag” is turned on, the return mail to the mail indicates the approval of the update of the data. Then, when the update is completed, the “flag” is turned off. When the return mail indicates that the update of the data is not approved (the update of the data is not required), the “flag” may be turned off when confirming the content of the return mail.

When the user or manager demands the approval procedure of the update of the data with respect to the copying machine as described above, the information necessary for the approval procedure is stored in the table. After the update is approved by the user or manager, the actual update is executed with respect to the copying machine. Accordingly, the update process can be executed in response to the request of the user or manager of the copying machine, and the management server can be prevented from automatically executing the update of the data with respect to the copying machine regardless of a user's or manager's intention.

Next, the error process will be described.

Here, the error process performed when there is not any response from the copying machine for a given time or more after the management server 11 transmits the update data will be described. It is to be noted that as causes for an error in the process of the update, a trouble in communication or a trouble generated at a rewrite time of the data of the ROM in the copying machine is considered. For example, when the copying machine cannot normally receive the update data because of the trouble in the communication, or when such an error that the operation of the copying machine is impossible is generated at the rewrite tie of the ROM in the copying machine, it is expected that the response from the copying machine is not obtained.

FIG. 6 is a flowchart showing an example of the error process.

That is, when it is judged in the step S21 that there is not any response from the copying machine within the predetermined time, the CPU 101 starts the error process. In this error process, the CPU 101 first makes an inquiry as to the copying machine (step S41). It is to be noted that with a state in which a normal operation is possible in each copying machine, a process situation of the update is notified (response) with respect to the inquiry from the management server 11.

When there is no response from the copying machine with respect to the inquiry (step S42, NO), the CPU 101 notifies the error to the management terminal 12 (step S44). Accordingly, the management terminal 12 executes notification of the error such as display of the error with respect to the service man in the service station.

Moreover, when there is a response to the inquiry (step S42, YES), the CPU 101 judges whether or not the response content from the copying machine is the notification of the generation of the error (step S43). That is, when the response content from the copying machine is the notice of the generation of the error (step S43, YES), the CPU 101 advances to the step S44.

Furthermore, when the response content from the copying machine is not the notice of the generation of the error (for example, when the execution of an update operation is notified, or when retry of the update operation is notified), the CPU 101 returns to the step S21 to wait for a predetermined time until the update completion notice is received from the copying machine (step S45). It is to be noted that when the update completion notice cannot be received from the copying machine for this predetermined time, the CPU 101 again executes the error process.

As described above, in the present embodiment, after the update data is transmitted, the completion of the update of each copying machine is determined based on the completion notice from the copying machine. Accordingly, the management server of the service station can monitor whether or not each copying machine has normally completed the update. Furthermore, when there is no response to the inquiry, or when there is a response notifying the generation of the error with respect to the inquiry, it is judged that the error is generated in the copying machine during the update. The generation of the error is notified to a management terminal in the service station. Accordingly, when an error is generated in the copying machine, the service man can promptly act.

Next, an operation of the copying machine that has received the update data from the management server will be described.

Here, an operation in a case in which the copying machine 22 has received the update data from the management server will be described.

First, on receiving the update data from the management server 11 (step S51), the system control section 121 of the copying machine 22 once stores the received update data in the HDD 144 (step S52). When the update data is stored in the HDD, the system control section 121 judges whether or not the update request by the update data has been received from the management server 11 (step S53).

The update request may be transmitted together with the update data, or separately from the update data. When the update request is transmitted together with the update data, the system control section 121 starts the operation of the update on receiving the update data. When the update request is transmitted separately from the update data, the system control section 121 starts the operation of the update after starting the update data in the HDD and receiving the update request from the management server 11.

For example, when the update is performed based on the approval of the update received from the user or manager by the approval procedure, the management server 11 transfers the update data to the copying machine beforehand, and may send the update request to the copying machine after obtaining the approval from the user or manager.

When it is judged by the above-described judgment that the update request from the management server 11 has been received, the system control section 121 performs a process of prohibiting the operation other than the update operation (step S54). This is a process for stably performing the update operation. When the operation other than the update operation is prohibited, the system control section 121 identifies the ROM which is the object of the update by the update data (step S55). Accordingly, when the ROM which is the object of the update is identified, the system control section 121 executes a rewrite process (update operation) of rewriting the data of the ROM into the update data (step S56). When this rewrite process normally ends (step S57, YES), the system control section 121 notifies to the management server 11 via the internet 5 that the update has also normally ended (step S58). Furthermore, when the notice to the management server 11 ends, the system control section 121 obtains a state in which the usual operation is possible (step S59). In this case, when restart of the copying machine is necessary in order to set the updated content to be effective, the system control section 121 restarts the copying machine to validate the update data.

Moreover, when the rewrite process of the ROM does not normally end (step S57, NO), the system control section 121 judges whether or not the rewrite process of the ROM can be again executed (retried) (step S60).

When it is judged by the judgment that the retry is possible (step S60, NO), the system control section 121 returns to the step S56 to execute the rewrite process of the ROM again. When it is judged by the judgment that the retry is impossible (step S60, YES), the system control section 121 transmits an error notice indicating failure in the update to the management server 11 in a state in which the communication with the management server 11 is possible (step S61).

Moreover, when the above-described error notice is transmitted, that is, when it is impossible to retry the rewrite process of the ROM, the system control section 121 stops the operation of the copying machine (step S62), and waits for the action by the service station.

For example, even when an error is generated in the rewrite process of the ROM, the system control section 121 can sometimes execute the rewrite process of the ROM again. Even when an error is generated in the rewrite process of the ROM in this manner, when it is possible to execute the rewrite process of the ROM again, the system control section 121 retries the rewrite process of the ROM based on the update data stored in the HDD 144.

Moreover, when an error is generated in the rewrite process of the ROM, when the system control section 121 cannot retry the rewrite process of the ROM, the error notice to the management server 11 is sometimes possible. In this case, the system control section 121 executes the error notice indicating the update onto the management server 11 has failed.

Furthermore, when an error is generated in the rewrite process of the ROM, the system control section 121 cannot retry the rewrite process of the ROM, and cannot sometimes execute the error notice to the management server 11. In this case, the copying machine is brought into a stopped state. For example, when an error is generated in the rewrite process of the ROM 121a of the system control section 121, for the system control section 121, all the operations are impossible. Both the retry of the rewrite process of the ROM and the error notice to the management server 11 become impossible in many cases. In this case, since the copying machine makes no response to the inquiry from the management server 11, it is detected by the above-described error process that the management server 11 has failed in the update.

As described above, each copying machine stores the update data from the management server 11 in the HDD, and executes the actual update operation following the update request from the management server 11. Accordingly, each copying machine can perform the update in accordance with the request of the management server 11.

Next, one example of an update process of the table 104a will be described.

The table 104a may be updated by the service man in the service station, or may automatically be updated in accordance with a connection situation of the optional apparatus with respect to each copying machine. Here, a case will be described in which the table is automatically updated in accordance with the connection situation of the optional apparatus with respect to each copying machine.

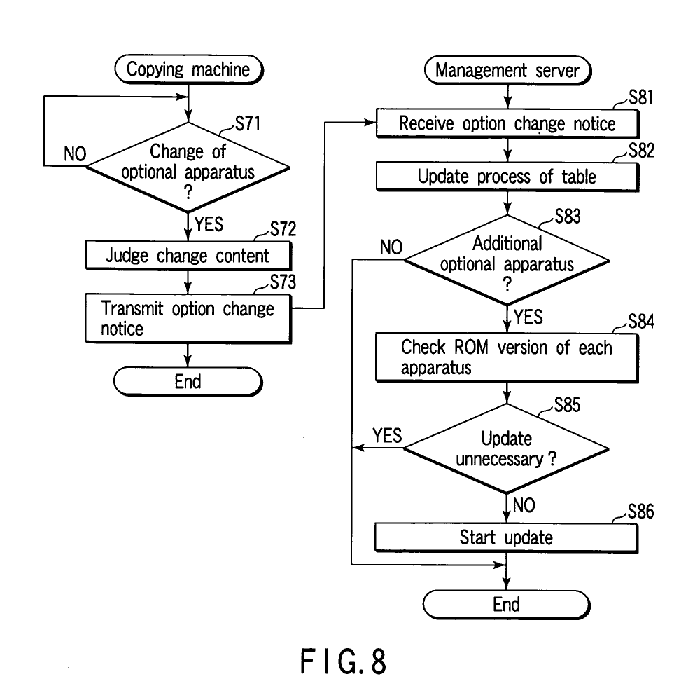

FIG. 8 is a flowchart showing a process of updating the table in accordance with the connection situation of the optional apparatus with respect to each copying machine.

First, it is assumed that the connection situation (option constitution) of the optional apparatus with respect to the copying machine on the present network has been changed. When the optional apparatus is connected or disconnected with respect to the copying machine main body, the system control section 121 of each copying machine senses the signal.

That is, when the connection or disconnection of the optional apparatus is detected (step S71, YES), the system control section 121 of the copying machine identifies the changed optional apparatus, and judges the change content of the optional apparatus (step S72). In this case, when the optional apparatus is added, the version information (ROM version) of the data stored in the ROM in the optional apparatus is also judged.

When the change content of the optional apparatus is judged by this judgment, the system control section 121 transmits an option change notice indicating the content of the changed optional apparatus is transmitted to the management server 11 (step S73). The option change notice includes at least information indicating the copying machine and information indicating the changed optional apparatus. Furthermore, when the optional apparatus is added, the option change notice also includes information indicating the ROM version in the optional apparatus.

The management server 11 can accept the option change notice from each copying machine as needed. When the above-described option change notice is received in this state (step S81), the CPU 101 of the management server 11 updates the information concerning the option in the copying machine of the table 104a based on the option change notice (step S82).

For example, when the ADF is added, the CPU 101 adds the ADF to the “option information” of the copying machine in the table 104a, and further writes the ROM version information of the ADF into the “ADFROM”. When the ADF is disconnected, the CPU 101 removes the ADF from the “option information” of the copying machine in the table 104a, and deletes the version information from the “ADFROM”.

By the above-described process (the steps S71 to S82), the update of the table 104a is completed.

Furthermore, in the present embodiment, when the ROM version of the added optional apparatus is not the latest, the update with respect to the copying machine is executed. For example, when the ROM version of the newly added optional apparatus is the latest, the rewrite process of the ROM is normally unnecessary. However, when the version is not the latest, the rewrite process (version upgrade) of the ROM is necessary.

When there is an additional optional apparatus in the present embodiment, the ROM version is checked to judge whether or not the version upgrade is necessary. It is to be noted that the latest update data with respect to the ROM of each section in each copying machine is accumulated in the management server 11.

That is, when the rewrite of the table is completed in the step S82, the CPU 101 judges whether or not the rewritten content is associated with the addition of the optional apparatus (step S83). When it is judged by this judgment that there is no addition of the optional apparatus (step S83, NO), the CPU 101 ends a series of processes.

Moreover, when it is judged by this judgment that the optional apparatus has been added (step S83, YES), the CPU 101 compares the ROM version of the changed optional apparatus with the version information of the latest update data accumulated in the management server 11 (step S84).

The CPU 101 judges by this comparison whether or not the update by the latest update data is unnecessary for the ROM version of the changed optional apparatus (step S85). When it is judged by this judgment that the update is unnecessary (step S85, YES), the CPU 101 ends a series of processes in the CPU 101.

Moreover, when it is judged by the judgment that the update is necessary, the CPU 101 executes the update process of the ROM by a process similar to that of the steps S11 to S24 (step S86).

As described above, when each copying machine has a change in the optional apparatus, each copying machine transmits the option change notice indicating the change content of the optional apparatus to the management server, and the management server updates the table based on the option change notice. Accordingly, the trouble of updating the table by the service man is saved, and it is possible to quickly update the table with respect to the change of the optional apparatus of each copying machine.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A management server connected via a network to a plurality of devices each of which can selectively be connected to various optional apparatuses each including at least one memory and each of which comprises a main body including at least one memory, the management server comprising:
a table where information indicating a state of each device which is a management object is stored;
a judgment section which judges a device requiring update based on the information stored in the table to indicate the state of each device, when update data is acquired with respect to data stored in the memory in each device which is the management object; and
a communication interface which transmits the update data to the device judged to require the update by the judgment section.

2. The management server according to claim 1, wherein at least information indicating the optional apparatus connected to the main body of each device is stored as the information indicating the state of each device which is the management object in the table, and
the judgment section judges the device requiring the update by the update data based on the information which is stored in the table and which indicates the optional apparatus connected to the main body of each device, when the update data is acquired.

3. The management server according to claim 2, further comprising:
an update section of the table, which updates the information stored in the table and indicating the optional apparatus connected to the main body of the device based on an option change notice, when receiving the option change notice indicating that the device which is the management object is changed to the optional apparatus connected to the main body by the communication interface.

4. The management server according to claim 1, wherein at least information indicating a version of data stored in each memory in each device is stored as the information indicating the state of each device which is the management object in the table, and
the judgment section judges the device requiring the update based on the information indicating the version of the update data and the information stored in the table and indicating the version of the data stored in each memory in each device, when the update data and the information indicating the version of the update data are acquired.

5. The management server according to claim 4, further comprising:
an update section of the table, which updates the information indicating the version of the data stored in the memory in the device updated by the update data, when receiving a completion notice of the update by the update data from the device which has transmitted the update data by the communication interface.

6. The management server according to claim 1, wherein at least information indicating the optional apparatus connected to the main body of each device and a version of data stored in each memory in each device is stored as the information indicating the state of each device which is the management object in the table, and
the judgment section judges the device having a constitution which is an object of the update by the update data based on the information stored in the table to indicate the optional apparatus connected to the main body of each device, when acquiring the information indicating the update data and the version of the update data, and
judges the device requiring the update based on the information indicating the version of the update data and the information stored in the table to indicate the version of the data stored in each memory in each device with respect to the device judged to include the constitution which is the object of the update by the judgment.

7. The management server according to claim 1, further comprising:
an approval procedure section which performs an approval procedure to require an approval concerning the update of the data with respect to the memory in the device of a user or manager of the device,
wherein information indicating whether or not the approval procedure is necessary with respect to the update of the data is stored together with the information indicating the state of each device which is the management object in the table, and
the judgment section further judges whether or not the approval procedure is necessary with respect to the update of the device judged to require the update based on the table, and
the communication interface transmits the update data to the device which does not require the approval procedure or to the device which has obtained the approval of the update by the approval procedure section.

8. The management server according to claim 1, further comprising:
an error detection section which judges that an error is generated in the device, when a completion notice of the update by the update data cannot be received from the device which has transmitted the update data by the communication interface within a predetermined time.

9. An update system of data, comprising: a plurality of devices each of which can selectively be connected to various optional apparatuses each including at least one memory and each of which comprises a main body including at least one memory; and a management server connected to these devices via a network,
wherein the management server comprises:
a table where information indicating a state of each device which is a management object is stored;
a judgment section which judges a device requiring update based on the information stored in the table to indicate the state of each device, when update data is acquired with respect to data stored in the memory in each device which is the management object; and
a first communication interface which transmits the update data to the device judged to require the update by the judgment section, and
the device comprises:
a second communication interface in which data communication is possible with respect to the management server;
a distinction section which identifies a memory which is an object of the update by the update data received from the management server by the second communication interface; and
a rewrite processing section which carries out a rewrite process with respect to the data stored in the memory identified by the distinction section based on the update data.

10. The update system of the data according to claim 9, wherein at least information indicating the optional apparatus connected to the main body of each device is stored as the information indicating the state of each device which is the management object in the table, and
the judgment section judges the device requiring the update by the update data based on the information which is stored in the table and which indicates the optional apparatus connected to the main body of each device, when the update data is acquired.

11. The update system of the data according to claim 10, wherein the management server further comprises:
an update section of the table, which updates the information stored in the table and indicating the optional apparatus connected to the main body of the device based on an option change notice, when receiving the option change notice indicating that the device which is the management object is changed to the optional apparatus connected to the main body by the first communication interface.

12. The update system of the data according to claim 9, wherein at least information indicating a version of the data stored in each memory in each device is stored as the information indicating the state of each device which is the management object in the table, and
the judgment section judges the device requiring the update based on the information indicating the version of the update data and the information stored in the table and indicating the version of the data stored in each memory in each device, when the update data and the information indicating the version of the update data are acquired.

13. The update system of the data according to claim 12, wherein the management server further comprises:
an update section of the table, which updates the information indicating the version of the data stored in the memory in the device updated by the update data, when receiving a completion notice of the update by the update data from the device which has transmitted the update data by the first communication interface.

14. The update system of the data according to claim 9, wherein at least information indicating the optional apparatus connected to the main body of each device and a version of data stored in each memory in each device is stored as the information indicating the state of each device which is the management object in the table, and
the judgment section judges the device having a constitution which is an object of the update by the update data based on the information stored in the table to indicate the optional apparatus connected to the main body of each device, when acquiring the information indicating the update data and the version of the update data, and
judges the device requiring the update based on the information indicating the version of the update data and the information stored in the table to indicate the version of the data stored in each memory in each device with respect to the device judged to include the constitution which is the object of the update by the judgment.

15. The update system of the data according to claim 9, wherein the management server further comprises: an approval procedure section which performs an approval procedure to require an approval concerning the update of the data with respect to the memory in each device of a user or manager of the device,
information indicating whether or not the approval procedure is necessary with respect to the update of the data is stored together with the information indicating the state of each device which is the management object in the table, and
the judgment section further judges whether or not the approval procedure is necessary with respect to the update of the device judged to require the update based on the table, and
the first communication interface transmits the update data to the device which does not require the approval procedure or to the device which has obtained the approval of the update by the approval procedure section.

16. The update system of the data according to claim 9, wherein each device transmits a completion notice of the update to the management server by the second communication interface, when the rewrite processing section normally completes the rewrite process based on the update data received from the management server, and
the management server further comprises: an error detection section which judges that an error is generated in the device, when the completion notice of the update by the update data cannot be received from the device which has transmitted the update data by the first communication interface within a predetermined time.

17. An update method of data by a management server connected via a network to a plurality of devices each of which can selectively be connected to various optional apparatuses each including at least one memory and each of which comprises a main body including at least one memory, the method comprising:
storing information indicating a state of each device which is a management object in a table;
judging a device requiring update based on the information which is stored in the table and which indicates the state of each device, when update data is acquired with respect to the data stored in the memory in each device which is the management object; and
transmitting the update data with respect to the device judged to require the update by the judgment.

18. The update method of the data according to claim 17, further comprising:
storing at least information indicating the optional apparatus connected to the main body of each device as the information indicating the state of each device which is the management object in the table,
wherein the judging comprises: judging the device requiring the update by the update data based on the information which is stored in the table and which indicates the optional apparatus connected to the main body of each device, when the update data is acquired.

19. The update method of the data according to claim 17, further comprising:
storing at least information indicating a version of data stored in each memory in each device as the information indicating the state of each device which is the management object in the table,
wherein the judging comprises: judging the device requiring the update based on the information indicating the version of the update data and the information stored in the table and indicating the version of the data stored in each memory in each device, when the update data and the information indicating the version of the update data are acquired.

20. The update method of the data according to claim 17, further comprising:
storing at least information indicating the optional apparatus connected to the main body of each device and a version of data stored in each memory in each device as the information indicating the state of each device which is the management object in the table,
wherein the judging comprises:
judging the device having a constitution which is an object of the update by the update data based on the information stored in the table to indicate the optional apparatus connected to the main body of each device, when acquiring the information indicating the update data and the version of the update data; and
judging the device requiring the update based on the information indicating the version of the update data and the information stored in the table to indicate the version of the data stored in each memory in each device with respect to the device judged to include the constitution which is the object of the update by the judgment.
